(19) United States
(12) Patent Application Publication
(10) Pub. No.: US 2011/0205115 A1
(43) Pub. Date: Aug. 25, 2011

(54) Always on GPS Device

(75) Inventors: Steven A. Gronemeyer, Cedar Rapids, IA (US); Mark A. Sturza, Encino, CA (US); Donald Leimer, Rancho Palos Verdes, CA (US); Sanjai Kohli, Manhattan Beach, CA (US)

(73) Assignee: SiRF Technology, Inc., San Jose, CA (US)

(21) Appl. No.: 12/347,857

(22) Filed: Dec. 31, 2008

Related U.S. Application Data
(60) Provisional application No. 61/031,321, filed on Feb. 25, 2008.

(51) Int. Cl. G01S 19/34

(52) U.S. Cl. 342/357.74

(57) ABSTRACT

A wireless device including a transceiver that utilizes a power supply is described. The wireless device includes a Global Positioning System (“GPS”) section having a plurality of GPS subsystems and a power controller in signal communication with the power supply and GPS section, wherein the power controller is configured to selectively power each GPS subsystem from the plurality of GPS subsystems.

### CROSS-REFERENCE To RELATED APPLICATIONS

This application claims priority under 35 U.S.C §119(e) to U.S. Provisional Application Ser. No. 61/031,321, titled “Always On GPS Device,” filed on Feb. 25, 2008, all of which is incorporated into this application by reference in its entirety.

### BACKGROUND OF THE INVENTION

1. Field of Invention

This invention relates in general to satellite navigation systems and in particular to wireless communication devices utilizing a Global Positioning System (“GPS”) receiver.

2. Related Art

The use of telecommunication devices in present day society has grown at an enormous rate. At present, the demand for portable telecommunication devices such as cellular telephones, Wi-Fi® and Bluetooth® enabled portable devices, Personal Communication Service (“PCS”) devices, Global Positioning System (“GPS”) enabled portable devices, etc., is growing in popularity every day. As the demand increases for portable telecommunication devices with varying communication characteristics, manufactures are seeing a need to combine and integrate many of these devices. As an example, there is a need to integrate cellular telephones (i.e., “cellphones”) with GPS receivers in order to allow a cellphone to determine its position for both personal and emergency use.

In FIG. 1, a block diagram of an example of a known implementation of a wireless device 100 communicating with a wireless network 102 and GPS satellites 104. The wireless device 100 may be, for example, a cellphone and it may include a wireless transceiver 106, a GPS receiver 108, and battery 110. In operation, the wireless transceiver 106 may be in signal communication with communication network 102 via wireless signal path 112 and basestation 114 and the GPS receiver 108 may be in signal communication with the GPS satellites 104 via wireless signal path 116. The GPS satellites 104 transmit spread spectrum signals via wireless signal path 116 that are received by the wireless device 100. For ease of illustrative purposes, only a single satellite is shown in FIG. 1 and other GPS satellites 104 are not shown; however, other GPS satellites 104 may also be transmitting signals that are received by the GPS section 108 of the wireless device 100.

The need for integrating cellphones with GPS receivers is a result of U.S. Congress though the FCC mandating that cellular service providers report the position of a cellular handset that has dialed 911 to an emergency call center. The required accuracy is 100 meters for 67 percent of emergency calls, 300 meters for 95 percent of emergency calls for network-based solutions, and 50 meters for 67 percent of calls and 150 meters for 95 percent of calls for handset-based solutions. To comply with this mandate, many service providers require that handsets used on their system contain embedded GPS receivers. The FCC has extended the requirement for “E911” position reporting to VoIP service providers and to satellite telephone service providers. Handset standby time is very important to consumers, and hence to service providers.

Unfortunately, location based services require near instant position fixes that require significant power; these fixes, however, can be refined over the next several seconds for improved accuracy. In general, embedded GPS receivers can provide near instant position fixes provided they have minimal time, frequency, and to some extent, position uncertainties predetermined. Unfortunately, at present GPS receivers do not have the ability to operate continuously without draining the battery.

Known approaches to this problem have included utilizing power cycling modes that have about 10 dB-Hz stronger signal requirements for the same or greater energy expenditure of the battery. These approaches include making fixed (i.e., blind) uncertainty assumptions about the real-time clock (“RTC”) when using the RTC to store time. Unfortunately, these cycling mode approaches do not use stationary assumptions and/or indoor assumptions to determine how measurements made within the cycle are used or interpreted; instead, these approaches generally return the GPS receiver to full power operation. These approaches do not take advantage of the Temperature Controlled Crystal Oscillator (“TCXO”) stability in the absence of GPS measurements. Additionally, these approaches do not infer temperature or temperature rate from relative RTC and TXCO frequency and they do not operate against an energy constraint because they only operate against an update rate.

Aiding information can be provided over communications networks, but this requires the ability to receive the aiding information over a communications network. Thus, it is desirable for an embedded GPS receiver to maintain accurate estimates of time, frequency, and position. These accurate estimates also would allow the embedded GPS receiver to acquire signals at lower levels.

Therefore, there is a need for a system and a method capable of minimizing the battery drain of the embedded GPS receiver.

### SUMMARY

A wireless device including a transceiver that utilizes a power supply is described. The wireless device includes a Global Positioning System (“GPS”) section having a plurality of GPS subsystems and a power controller in signal communication with the power supply and the GPS section, wherein the power controller is configured to selectively power each GPS subsystem from the plurality of GPS subsystems.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 is a block diagram of an example of a known implementation of a wireless device communicating with a wireless network and a plurality of Global Positioning System (“GPS”) satellites.

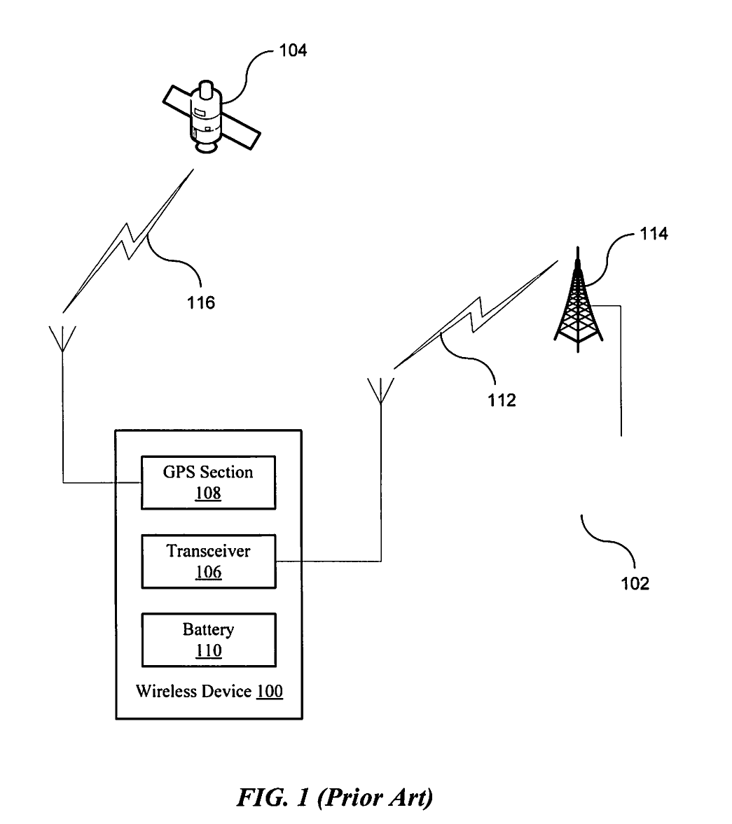

FIG. 2 is a block diagram of an example of an implementation of a wireless device in accordance with the invention.

FIG. 3 is a block diagram of an example of an implementation of a wireless device utilizing the power controller and the GPS section shown in FIG. 2 in accordance with the invention.

FIG. 4 is a block diagram of an example of an implementation of the GPS section shown in FIGS. 2 and 3 in accordance with the invention.

FIG. 5 is a flowchart of an example of an implementation of method performed by the power controller, shown in FIG. 3, in operation in accordance with the invention.

FIG. 6 is a block diagram of an example of an implementation of a wireless device utilizing a power controller to selectively power a GPS section in accordance with the invention.

FIG. 7 is a block diagram of an example of another implementation of a wireless device utilizing a power controller and a motion sensor to selectively power a GPS section in accordance with the invention.

FIG. 8 is a block diagram of an example of another implementation of the wireless device utilizing a power controller to selectively power a GPS section in accordance with the invention.

FIG. 9 is a block diagram of an example of another implementation of the wireless device utilizing a power controller to selectively power a GPS section in accordance with the invention.

### DETAILED DESCRIPTION

In the following description of examples of implementations, reference is made to the accompanying drawings that form a part hereof, and which show, by way of illustration, specific implementations of the invention that may be utilized. Other implementations may be utilized and structural changes may be made without departing from the scope of the present invention.

In the following description of examples of embodiments, reference is made to the accompanying drawings that form a part hereof, and which show, by way of illustration, specific implementations of the invention that may be utilized. Other implementations may be utilized and structural changes may be made without departing from the scope of the present invention.

Described herein are systems and methods for minimizing the drain of a power supply within a wireless device that has a Global Positioning System (“GPS”) section. Specifically, a wireless device having a transceiver and that utilizes a power supply is described. The wireless device may include a GPS section having a plurality of GPS subsystems and a power controller in signal communication with the power supply and the GPS section. The power controller is configured to selectively power each GPS subsystem from the plurality of GPS subsystems.

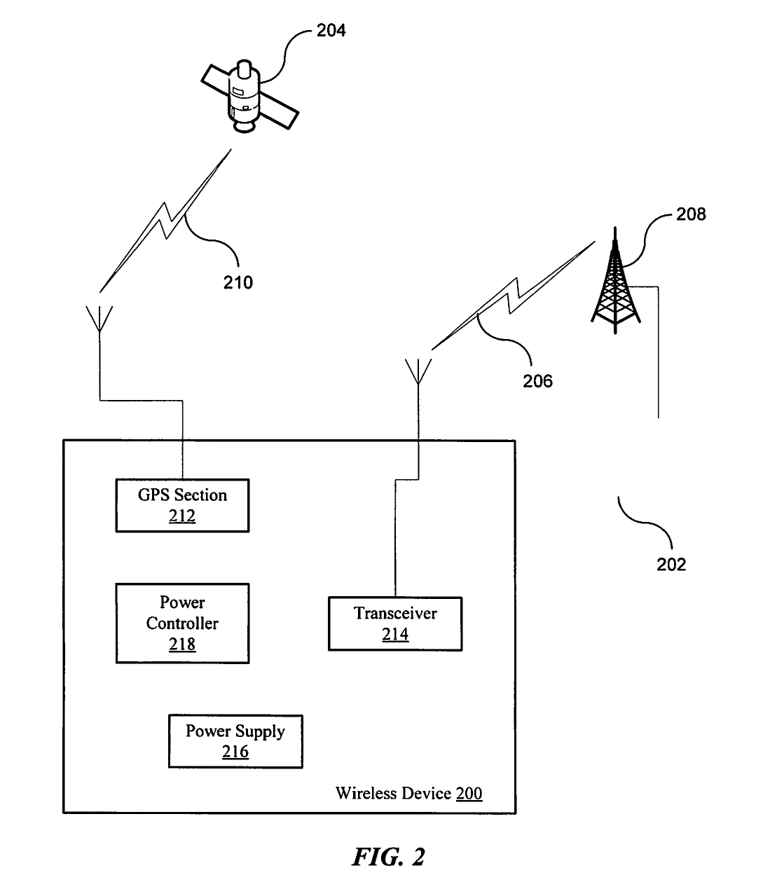

As an example, in FIG. 2, a block diagram of an example of an implementation of a wireless device 200 is shown in signal communication with a communications network 202 via wireless signal path 206 and basestation 208 and GPS satellites 204 via signal path 210. The wireless device 200 may include a GPS section 212, transceiver 214, power supply 216, and a power controller 218. The GPS section 212 is embedded in the wireless device 200 to allow determination of the location of the wireless device 200. This location information may be provided to the user (not shown) of the wireless device 200, an operator (not shown) of the communications network 202 or to a third party (not shown) through the communications network 202.

Also described is a power controller utilized in a wireless device having a GPS section that has a plurality of GPS subsystems. The power controller may include a first input, a second input, a plurality of outputs, and a controller. The first input is capable of receiving an input power signal from a power source within the wireless device and the second input is capable of receiving an input power control signal. Each output from the plurality of outputs is capable of being in signal communication with a corresponding GPS subsystem from the plurality of GPS subsystems and the power controller is capable of both selecting each output from the plurality of outputs and sending a power signal from the selected output.

As an example of operation, the power controller is capable of performing a method that includes receiving an input power signal from a power source within the wireless device and receiving an input power control signal. The power controller is then capable of selecting an output from the plurality of outputs and sending an output power signal from the input power signal from the selected output to a GPS subsystem from the plurality of GPS subsystems.

It is appreciated by those skilled in the art that the circuits, components, modules, and/or devices of the wireless device 200 are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

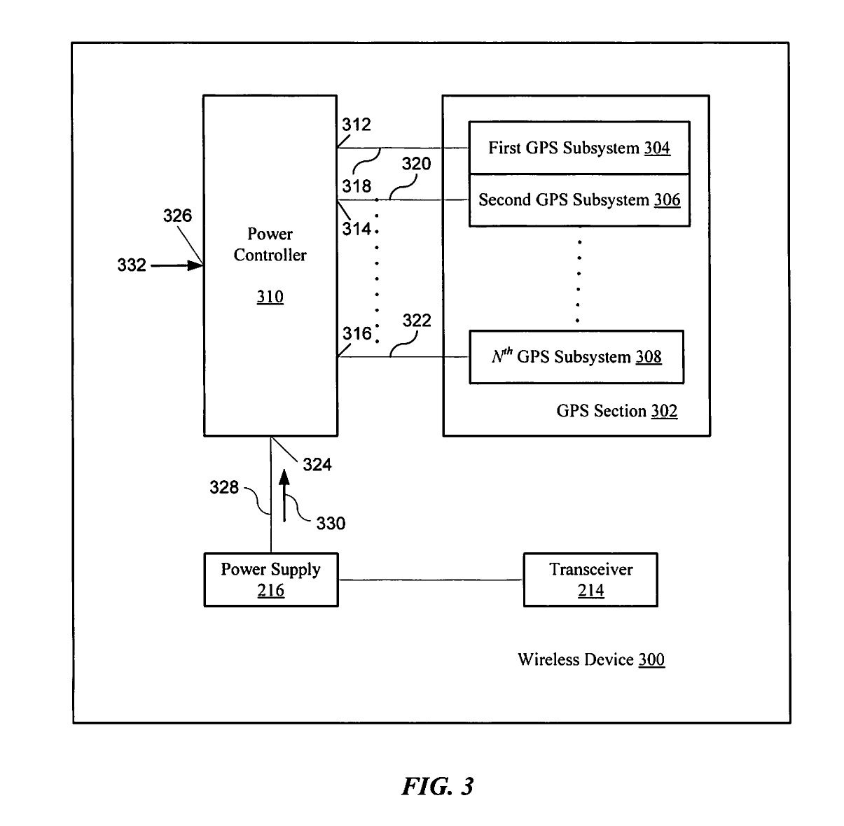

As an example, in FIG. 3, another block diagram of the wireless device 300 is shown where the GPS Section 302 is shown to include a plurality of GPS subsystems ranging from first GPS subsystem 304, second GPS subsystem 306 to a N^{th} GPS subsystem 308. In this example, the power controller 310 is shown to have a plurality of outputs 312, 314, and 316 that are in signal communication with the plurality of GPS subsystems via signal paths 318, 320, and 322, respectively. The power controller 310 also has a first input 324 and second input 326 and is in signal communication with the power supply 216 via signal path 328. As an example, the plurality of GPS subsystems may include radio frequency (“RF”) and intermediate frequency (“IF”) front-end circuitry, baseband circuitry, and controller/processor subsystems.

In operation, the power controller 310 is capable of receiving a power signal 330 from the power supply 216 into the first input 324 via signal path 328 and a control signal 332 into the second input 326. In response, the power controller 310 is capable of selecting an output from the plurality of outputs 312, 314, and 316 and sending a power signal (not shown) from the power controller 310 through the selected output to the corresponding GPS subsystem of the plurality of GPS subsystems 304, 306, and 308. In this example, the power signal (not shown) would be related to received power signal 330.

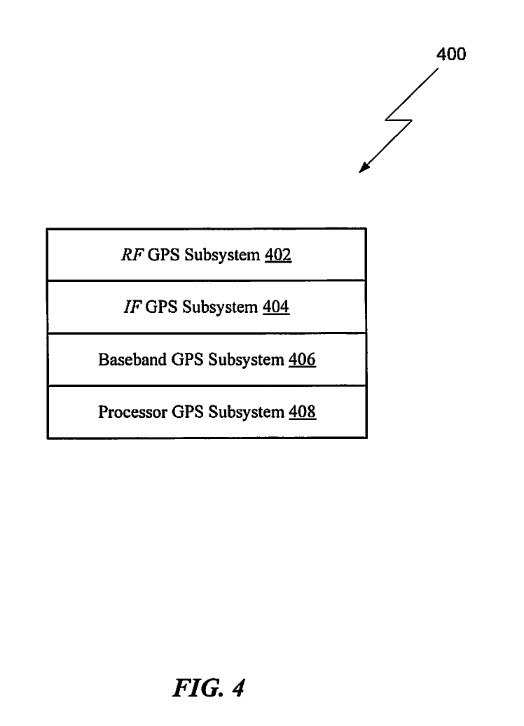

In FIG. 4, a block diagram of an example of an implementation of the GPS section 400 is shown. In this example, the GPS section 400 may include a plurality of GPS subsystems that may include a RF GPS subsystem 402, IF GPS subsystem 404, baseband GPS subsystem 406, and processor GPS subsystem 408.

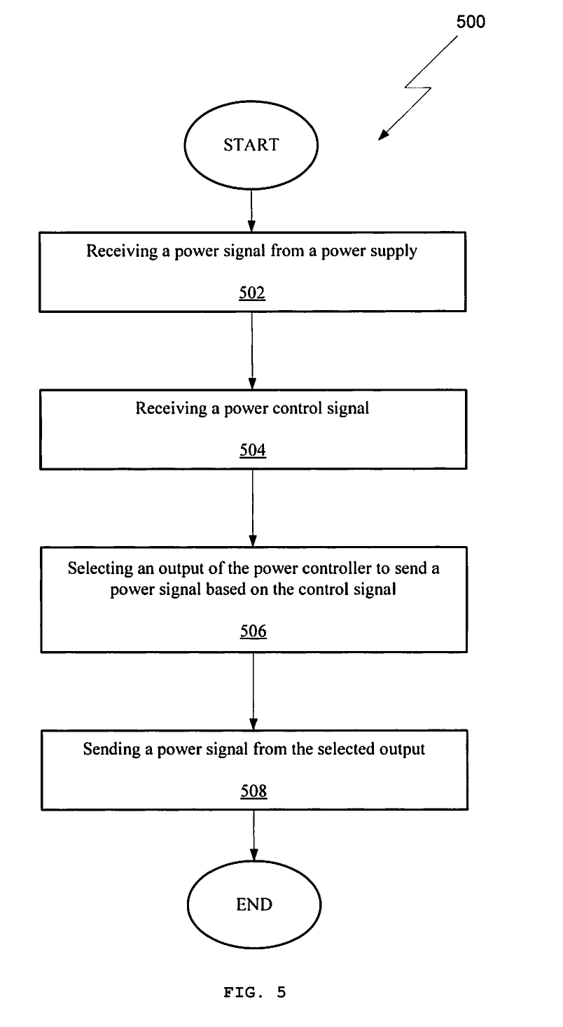

FIG. 5 is a flowchart 500 of an example of an implementation of method performed by the power controller 310, FIG. 3, in operation as was described above. The process starts in step 502 where the power controller receives a power signal from the power supply. The power controller then receives a power control signal in step 504 and, in step 506, the power controller selects an output of the power controller to send a power signal to the GPS section having a plurality of GPS subsystems based on the power control signal. The power controller then, in step 508, sends the power signal from the selected output to a corresponding GPS subsystem.

The invention reduces the energy per fix, improves the Time-To-First-Fix (“TTFF”), and reduces or eliminates the need for data aiding to provide continuous positioning with high probability at low power in weak signal or indoor environments. The invention accomplishes these goals by managing the time and frequency uncertainties to minimize the need for bit and/or frame synchronization (i.e., “bit sync” or “frame sync”).

As an example, generally in weak signal environments, data collection will often not be possible because GPS signals and measurements for position update will not be available. A typical working assumption in these environments is that the position of the wireless device is static and as such the GPS section is put into a time maintenance mode. Generally, in time maintenance mode the GPS section is turned on (i.e., “wake up”) only to the extent necessary to keep the time uncertainty of the GPS section to within ±¼ of a coarse/acquisition (“C/A”) code period. The reason for this is because bit sync and frame sync are generally not necessary when GPS signals and corresponding measurements are available since the requirements for bit sync and frame sync greatly increase the TTFF and power consumption of the GPS section.

In this time maintenance mode, the GPS section operates in a low power mode and wakes up occasionally to capture a relatively short sequence of RF sample data. A real-time clock (“RTC”) (such as, for example, a low cost watch crystal running at 32,768 Hz) is used for maintaining time in the GPS section between wake ups. Any data captured by the GPS section while in the wake up state is synchronized to predictable data segments. As such, the GPS section may operate as a timing receiver in a weak signal environment by assuming a static position of the GPS section and verifying this hypothesis whenever measurements can be taken. This process utilizes telemetry data (“TLM”) or predictable hand-over-word (“HOW”) words for data aiding because generally there are two short data sequences contained in the GPS data message that occur periodically and are predictable, which include a 22-bit TLM word and a 22-bit HOW word. When the GPS section is in the time maintenance mode, the time accuracy of the GPS section is maintained to be adequate to predict the location of these data words in the received message. Since the TLM and HOW bit sequences can be predicted, the GPS section can remove phase transitions of the signal that had been created by the data modulation during the TLM and HOW sequences. This process is called “data stripping.” After the phase transitions are removed, the GPS section can coherently integrate the signal for a duration much longer than a 20-ms data bit. The longer coherent integration enables the GPS section to synchronize to the received time and frequency with proportionately weaker signals. Thus, longer coherent integration using data stripping is utilized to enable GPS measurements at lower signal levels.

After the GPS data samples are captured, the RF front-end subsection of the GPS section (i.e., a GPS subsystem of the GPS section) is turned off to save power. The captured GPS samples are then processed by the baseband subsection of the GPS section to recover the GPS signal measurements. As stated above, a goal for maintaining the time between GPS section operations is to avoid bit synchronization such that power consumption may be minimized and detection sensitivity increased by performing longer coherent integration with data aiding.

A problem with maintaining time in the GPS section between wake ups is that the frequency error of the RTC varies as a function of temperature where the frequency error is least sensitive to temperature variations when the ambient temperature is approximately 22° C., while being most sensitive to temperature variations at temperature extremes. As such, in order to maintain accurate time for a given rate of temperature change, the interval between GPS sampling utilized by the GPS section may be adaptive where more frequent GPS sampling is performed by the GPS section at temperature values that are extreme than at temperature values near 22° C. Alternatively, instead of using temperature values, the frequency of GPS sampling may be adapted based on the observed RTC clock frequency or the rate of change of the RTC clock frequency as compared to previous sampling. As another alternative, when the wireless device operates on a cellular telephone network, the frequency of GPS sampling by the GPS section in the wireless device may also be adapted based on the cellular Receive Signal Strength Indicator (“RSSI”) measurements. In general, to minimize power consumption, these sampling rates should be kept as low as possible while keeping the time uncertainty to within ±¼ of a C/A code period.

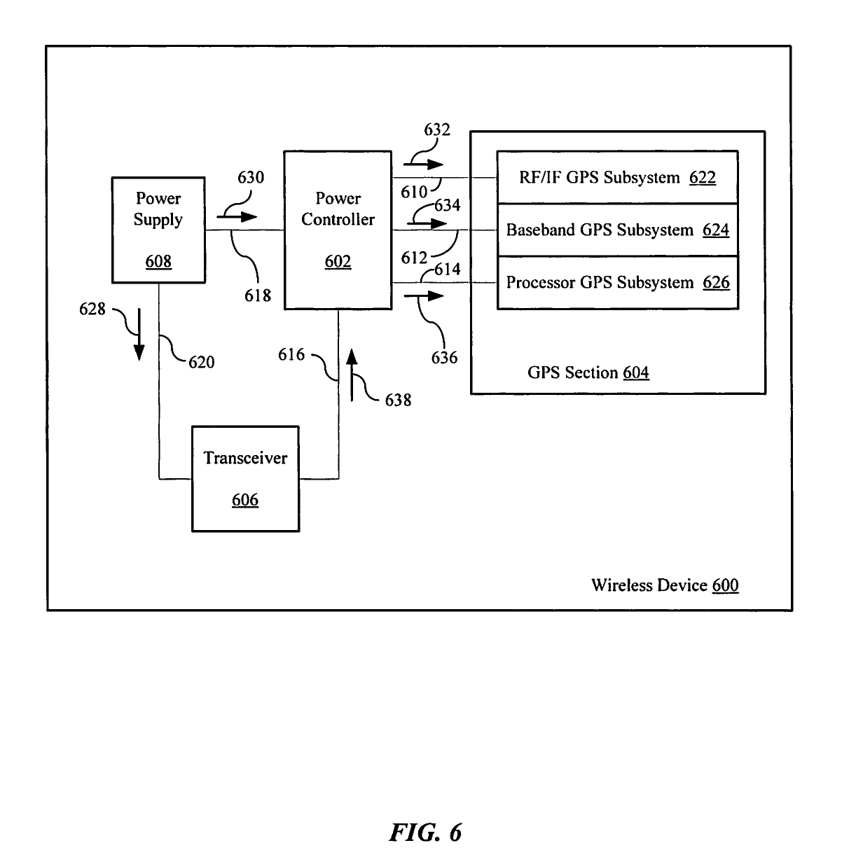

Turning to FIG. 6, a block diagram of an example of an implementation of a wireless device 600 utilizing a power controller 602 to selectively power a GPS section 604 is shown. The wireless device 600 may include the power controller 602, GPS section 604, a transceiver 606, and a power supply 608. In this example, the power controller 602 may be in signal communication with GPS section 604, transceiver 606, and power supply 608 via signal paths 610, 612, and 614, 616, and 618, respectively. The transceiver 606 may be in signal communication with the power supply 608 via signal path 620. The GPS section 604 may include a plurality of GPS subsystems that are a combined RF/IF GPS subsystem 622, a baseband GPS subsystem 624, and a processor GPS subsystem 626 that are in signal communication with the power controller 602 via signal paths 610, 612, and 614, respectively.

In this example, the wireless device 600 is a cellular wireless device where the transceiver 606 is a cellular transceiver. The wireless device 600 is configured such that each of the GPS section 604 subsystems (RF/IF 622, baseband 624, and processor 626) can be independently powered by the power controller 602.

In operation, the power supply 608 (which may be a battery) supplies a first power signal 628 to the transceiver 606 and a second power signal 630 to the power controller 602 via signal paths 620 and 618, respectively. The power controller 602 selectively powers each of the GPS subsystems (via output signals 632, 634, and 636) to perform GPS sampling and measurement based on a received power control signal 638 from the transceiver 606 (via signal path 616) where the received power control signal 638 includes information of the history of cellular RSSI measurements made by the transceiver 606.

As an example of operation, initially, the GPS subsystems 622, 624, and 626 may be turned on for 0.6 seconds every 60 seconds, which is a 1% duty cycle. The 0.6 second intervals would be aligned with one of the 30-bit GPS data words from one of the GPS satellites being tracked. The selected data words are cycled through the GPS ephemeris and clock data words for each of the GPS satellites being tracked. Once the ephemeris and clock data has been collected from each of the satellites being tracked, the GPS subsystems 622, 624, and 626 are then only turned on for 0.12 seconds every 60 seconds, which would be a 0.2% duty cycle.

If the ephemeris and clock data have been collected and the RSSI measurements from the transceiver 606 do not change significantly over a 60 second interval, then the subsystems 622, 624, and 626 are only turned on for 0.12 seconds every 120 seconds, which is a 0.1% duty cycle. If the RSSI measurements do not change significantly over a 120 second interval, then the interval is increased to 240 seconds, which is a 0.05% duty cycle. In general, as long as the RSSI measurements do not continue to change significantly over the interval, the interval duration may be increased up to a maximum of 960 seconds. This interval duration would be a 0.0125% duty cycle, which is approximately the largest duration value that would maintain the oscillator error (i.e., the RTC error) within acceptable limits.

If at any time during an interval in this process, the RSSI measurements change significantly, the interval is reset to 60 seconds. Additionally, if the RSSI measurements are not available because the transceiver 606 is not in service, the intervals are increased just as if the RSSI measurements have not changed significantly. Moreover, if the transceiver 606 reports that the available cellular basestations are changing rapidly, the GPS section 604 duty cycle is reduced until such time as the basestations stop changing rapidly. Once the basestations stop changing rapidly, the duty cycle is increased.

The action to be taken after the captured samples are processed depends on the number of GPS measurements acquired. During some updates, there may not be any measurement acquired if the signal level is too low. In these circumstances, the RTC time is updated based on the temperature-controlled crystal oscillator (“TCXO”). This is done by calculating the ratio of TCXO to RTC frequencies. This can be accomplished by capturing a set of RTC and TCXO counter values at the start and at the end of the sample capture time. The differences of the counter values between the two capture times provide the ratio of the TCXO to the RTC. Assuming the TCXO frequency is the last value calibrated from GPS, the change in RTC frequency since the previous update is then calculated. This additional frequency change is added to the changes that were accumulated since the last GPS-based update. The average between the current RTC frequency and the previous RTC frequency is used to scale the elapsed RTC time between updates. This scaled time delta is added to the current RTC time bias relative to GPS time. The uncertainty in GPS time is also updated based on the most pessimistic estimate that the RTC clock is in error by the maximum error of the TXCO. This GPS time uncertainty should be kept under ±¼ of a C/A code period to avoid bit sync ambiguity. Removing this ambiguity requires a GPS measurement. If a GPS measurement cannot be obtained within the GPS uncertainty of ±¼ of a C/A code, then bit synchronization would have to be performed when a GPS measurement becomes available at the cost of power consumption. Similarly, in order to avoid frame synchronization, the GPS time uncertainty should be kept within one data bit, or ±5 ms. Otherwise, data aiding would require multiple hypothesis testing that could be distributed among multiple updates to limit power consumption.

When a single GPS measurement is acquired, then the RTC time and frequency and the TCXO frequency can be updated. The unexpected change in code phase from the measurement provides an accurate measure of the RTC change from the last GPS update. This change is used to correct the RTC time bias relative to GPS and also to update the RTC frequency. The corrections are made assuming that the change in code phase is less than ±¼ of a C/A code so that there is no bit sync ambiguity. As before, the RTC and TCXO counter values at the start and end of the sample capture time provide the ratio of the TCXO to RTC frequency. The updated RTC frequency is then used with the TCXO/RTC frequency ratio to update the TCXO frequency estimate. If the uncertainty in the GPS time or the observed RTC code phase measurement is not consistent with the underlying assumption of no bit sync ambiguity, then additional processing with shifted data bit aiding offsets is executed to resolve the ambiguity.

When multiple measurements are acquired additional processing can be performed. Specifically, the static position hypothesis can be verified by ascertaining that the code phase correction for each satellite is consistent with a common time bias. The RTC time bias relative to GPS can then be corrected using the average of all the measured code phase change. Similarly, the RTC frequency can be updated with the average of the frequency correction for all the satellites since the last GPS update. Additionally, if enough measurements with good geometry are available, a full position update can be attempted, particularly if there is bit sync ambiguity.

Alternatively, RTC can be calibrated using temperature sensing as the RTC crystal's frequency error is a function of temperature. The crystal is also normally optimized to be least sensitive to temperature change at approximately 22° C., while it changes very rapidly with temperature change at extreme temperatures. Therefore, the interval of the update time can be made adaptive based on the estimated temperature and the change of temperature since the last update. In general, if higher rates of temperature change are experienced, the interval between updates will be reduced. Conversely, smaller temperature changes allow longer update intervals. The frequency ratio between the RTC and the TCXO implies a temperature that can be exploited to detect a temperature change. A temperature change is also an indication of power consumption change in the overall system or environmental change, both of which are likely to change the RF environment and possibly lead to better GPS signal environment. For example, an indoor environment tends to be at approximately 22° C. and provides a smaller temperature change with the implication of weak GPS signals. Conversely, the most extreme temperatures tend to be experienced outdoors but these environments also present a higher probability for strong GPS signals.

Data collection may also be initiated if GPS signal strength is strong enough and data is for a GPS satellite for which ephemeris is lacking For power considerations, data collection is to be avoided as long as extended ephemeris is available for a GPS satellite or when a newly risen satellite can be used with biased almanac pseudo-range. Extended ephemeris is a parameter that has a target life time on the order of one week compared to the 4 hour life span of ephemeris data broadcast by the GPS satellite. A GPS section 604 could obtain extended ephemeris by downloading from a network (not shown) or by computing it itself. Alternatively, a rising GPS satellite can be calibrated by calculating a range and drift for this satellites using almanac and biasing these measurement to the current time and position hypothesis. These biased GPS satellites can subsequently be used as measurement sources until an opportunity for data collection occurs.

This method provides robustness in the form of ability to adjust search uncertainty within the captured buffer. For example, dynamic adjustment of search window of time, frequency, and GPS satellite number can be made within the signal captured buffer and traded off against one another to meet power constraints. Search time can be extended to allow wider searches when uncertainties degrade or to search at lower sensitivity. As an example, if the GPS signal strength is low, then the interval the RF/IF GPS subsystem 622 is turned on is increased above the nominal 100 msec time. The intervals during which the RF/IF GPS subsystem 622 is turned on and digital samples are stored do not have to be continuous as long as the sub-intervals can be aligned with known GPS data bits to facilitate data stripping. Searches may also be controlled to remain within an energy constraint by ordering the GPS satellite search list and by distributing the search over multiple update times.

Even if no GPS measurement is acquired from the initial search, energy from multiple GPS satellites can be combined in a cross GPS satellite search to attempt a measurement. The objective is to obtain a single measurement so that the RTC time and frequency and the TCXO frequency can be updated as described previously. Each GPS satellite is searched over a range of code and frequency uncertainty space centered on a code phase and frequency. The center code phase for a satellite is the estimated satellite range in chips modulo-1023 to the nearest ½ chip and is different for each GPS satellite. Likewise, the center bin frequency for a GPS satellite is the estimated line-of-sight Doppler summed with the estimated clock drift to the nearest frequency bin and is different for each GPS satellite. Before performing cross GPS satellite combining, these uncertainty spaces are aligned so that their nominal centers are at the same value. Each GPS satellite has a set of peaks covering the code and frequency space searched. One GPS satellite is selected as the base GPS satellite. The sets of peaks of the other GPS satellites are then adjusted so that the center code phase and center frequency of each GPS satellite is aligned with the center code phase and center frequency of the selected base GPS satellite. In other words, the bin coordinate for each peak of each GPS satellite is differentially corrected so that the center bin for the GPS satellite is aligned with the center bin of the base GPS satellite. After differential correction of the peak coordinate, the magnitudes of peaks with like coordinates from all the GPS satellites are combined. If the current estimates of position, time, and frequency are perfect, the correlation peaks of all the GPS satellites would show up in the center bin of each GPS satellite. If the time is accurate enough such that the GPS satellite positions are accurate, any time error will bias the code phase of each GPS satellite in the same direction and the correlation peaks in code phase will still be closely aligned. Similarly, if the line-of-sight Doppler is accurate enough, any clock drift will bias the frequency bin of each GPS satellite in the same direction and the correlation peaks in frequency will also be closely aligned. The detect threshold applied to the non-coherent sum for a particular bin coordinate is a function of the number of terms (GPS satellites) in the non-coherent sum. The nominal procedure is to test the coordinate bins with the largest number of terms. Where adjacent bins have a higher total number of terms, interpolation and re-centering can also provide a more accurate estimate of peak coordinate bin for the combined signals. Thus, cross GPS satellite non-coherent combining with differential correction can be used to lower the detect threshold for a single GPS measurement.

In this example, a drop in the values of the cellular RSSI measurements may be used to detect that a building has been entered. In this event the GPS subsystems 622, 624, and 626 are immediately powered up so that a GPS fix can be taken. After the fix has been obtained, the GPS duty cycle is reduced. An increase in the values of the RSSI measurements then may be used to detect that the building has been exited. At that point, the GPS duty cycle would be increased.

It is appreciated by those skilled in the art that this invention is not limited to just cellular wireless devices. A GPS section could be embedded in a variety of handheld and portable devices that require low energy consumption. These devices include voice-over Internet protocol (“VoIP”) handsets, satellite phone handsets, cordless telephone handsets, PDAs, and notebook computers. Also, this invention is not limited to communications devices that operate over cellular networks. Other networks, such as Wi-Fi®, WiMAX, mobile TV, or satellite could also be used.

Additionally, this invention is not limited to using RSSI measurements for selective power control. Other types of measurements could be used for the power control signal that is input into the power controller.

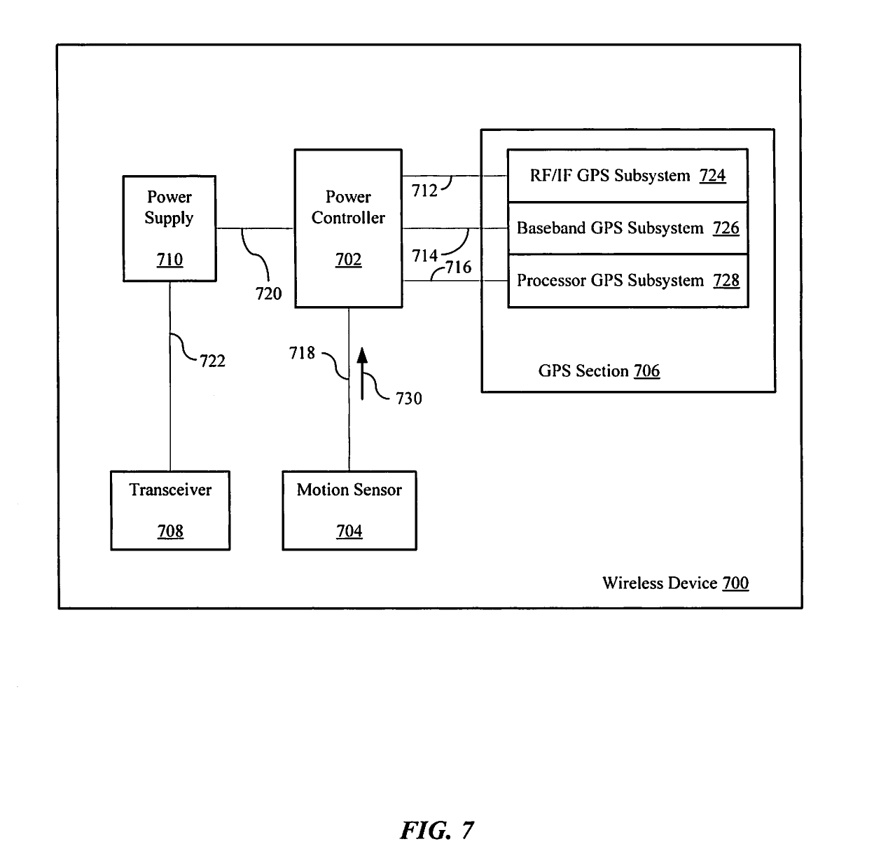

In FIG. 7, a block diagram of an example of another implementation of the wireless device 700 utilizing a power controller 702 and a motion sensor 704 to selectively power a GPS section 706 is shown.

The wireless device 700 may include the power controller 702, motion sensor 704, GPS section 706, a transceiver 708, and a power supply 710. In this example, the power controller 702 may be in signal communication with GPS section 706, motion sensor 704, and power supply 710 via signal paths 712, 714, and 716, 718, and 720, respectively. The transceiver 708 may be in signal communication with the power supply 710 via signal path 722. The GPS section 706 may include a plurality of GPS subsystems, which are a combined RF/IF GPS subsystem 724, a baseband GPS subsystem 726, and a processor GPS subsystem 728 that are in signal communication with the power controller 702 via signal paths 712, 714, and 716, respectively.

In an example of operation, the motion sensor 704 is used for selective power control, producing a power control signal 730 that is sent to the power controller 702 via signal path 718. When the motion sensor 704 sends a power control signal 724 that indicates that the wireless device 700 is stationary (for example, if the wireless device 700 is laying on a desk) the power controller 702 reduces the GPS section 706 duty cycle (i.e., the rate at which GPS samples are taken by the GPS section 706) to save power in the power supply 710. When the power control signal 730 sent by the motion sensor 704 indicates that the wireless device 700 is in motion, the power controller 702 increases the GPS section 706 duty cycle.

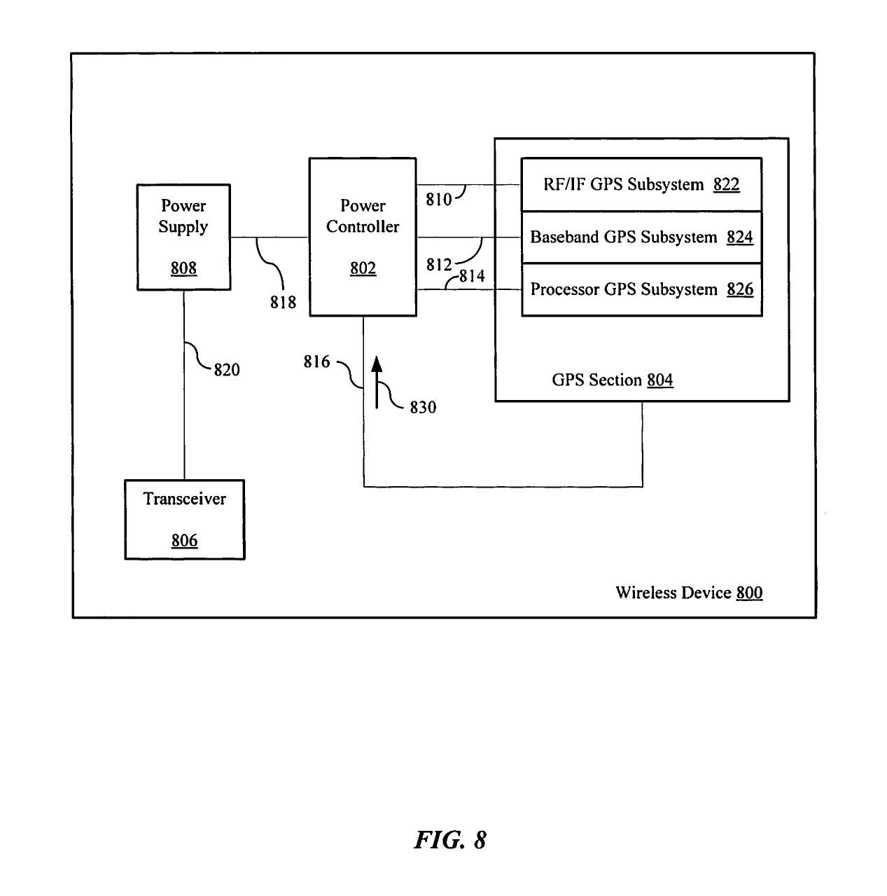

In FIG. 8, a block diagram of an example of another implementation of the wireless device 800 utilizing a power controller 802 to selectively power a GPS section 804 is shown. The wireless device 800 may include the power controller 802, GPS section 804, a transceiver 806, and a power supply 808. In this example, the power controller 802 may be in signal communication with the GPS section 804 and power supply 808 via signal paths 810, 812, 814, and 816, and 818, respectively. The transceiver 806 may be in signal communication with the power supply 808 via signal path 820. The GPS section 804 may include a plurality of GPS subsystems, which are a combined RF/IF GPS subsystem 822, a baseband GPS subsystem 824, and a processor GPS subsystem 826 that are in signal communication with the power controller 802 via signal paths 810, 812, and 814, respectively.

As an example of operation, velocity measurements from the GPS section 804 are used to create a power control signal 830 that is sent from the GPS section 804 to the power controller 802 via signal path 816. The power control signal 830 is utilized by the power controller 802 for selective power control of the GPS section 804. Each time the GPS section 804 is powered up to take a fix, the change in position from the last fix is computed and divided by the time since the last fix to determine the average velocity. If the average velocity is less than walking speed (approximately 2 miles per hour) or greater than driving speed (approximately 10 miles per hour), the time between fixes is increased. If the average velocity is between walking speed and driving speed, the time between fixes is decreased.

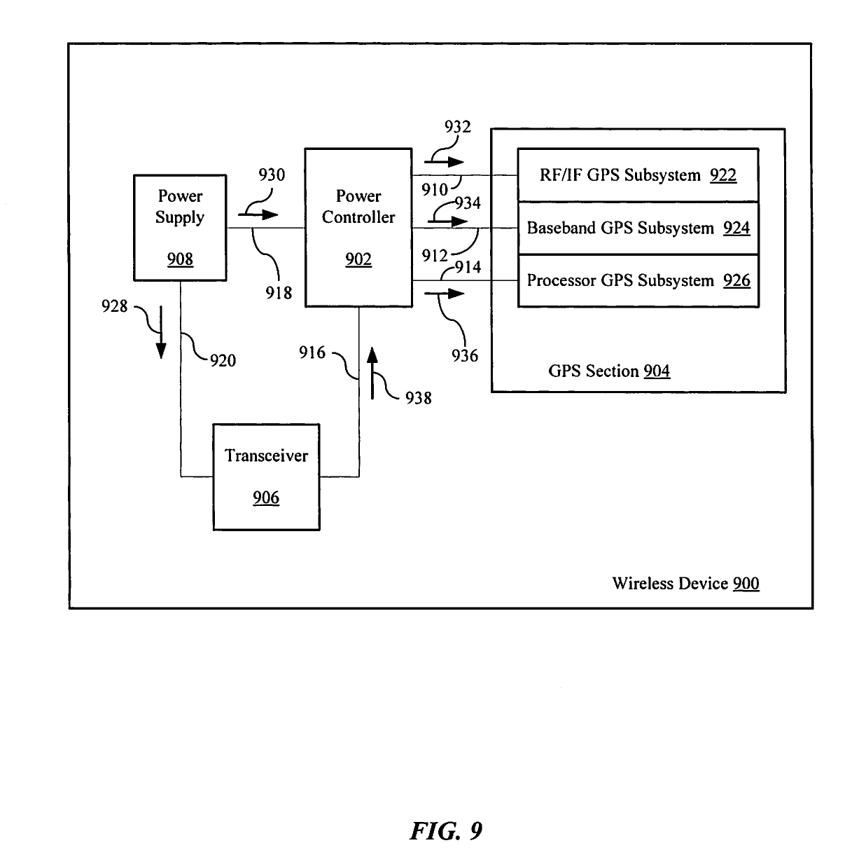

Turning to FIG. 9, a block diagram of an example of another implementation of a wireless device 900 utilizing a power controller 902 to selectively power a GPS section 904 is shown. The wireless device 900 may include the power controller 902, GPS section 904, a transceiver 906, and a power supply 908. In this example, the power controller 902 may be in signal communication with GPS section 904, transceiver 906, and power supply 908 via signal paths 910, 912, and 914, 916, and 918, respectively. The transceiver 906 may be in signal communication with the power supply 908 via signal path 920. The GPS section 904 may include a plurality of GPS subsystems, which are a combined RF/IF GPS subsystem 922, a baseband GPS subsystem 924, and a processor GPS subsystem 926 that are in signal communication with the power controller 902 via signal paths 910, 912, and 914, respectively.

Similar to the example in FIG. 6, in this example, the wireless device 900 is a cellular wireless device where the transceiver 906 is a cellular transceiver. The wireless device 900 is configured such that each of the GPS section 904 subsystems (RF/IF 922, baseband 924, and processor 926) can be independently powered by the power controller 902.

In operation, the power supply 908 supplies a first power signal 928 to the transceiver 906 and a second power signal 930 to the power controller 902 via signal paths 920 and 918, respectively. The power controller 902 selectively powers each of the GPS subsystems (via output signals 932, 934, and 936) to perform GPS sampling and measurement based on a received power control signal 938 from the transceiver 906 (via signal path 916) where the received power control signal 928 includes information of the Doppler measurements made by the transceiver 906. If the basestation Doppler shifts are small, the GPS section 904 duty cycle is reduced. If they increase, the duty cycle is also increased.

In general, the various implementation examples of this invention may utilize one or more of the following detection processes:

1) The RSSI samples are averaged for each signal over a time interval and differenced from those values computed over the previous interval. If the differences are less than a threshold, the device is considered to be stationary and the GPS duty cycle is maintained at a minimum value.

2) The RSSI samples are averaged for each signal over a time interval and differenced from those values computed over the previous interval. If the differences are less than a threshold, then the GPS section is powered off.

3) The RSSI samples are averaged for each signal over a time interval and the variance computed over several time intervals. If the variances are greater than a threshold, then diversity is turned on.

4) The cellular signal Doppler is measured for each signal. If the maximum Doppler exceeds a threshold, then the GPS section is configured to operate with strong signal levels.

5) The RSSI samples are averaged for each signal over a time interval. If the averaged RSSI samples for a given percentage (for example, approximately 75%) of the signals drop by more than a threshold amount in a specified number of minutes then it is assumed that the wireless device has entered a building and a immediate position fix is taken.

6) The RSSI samples are averaged for each signal over a time interval. If the averaged RSSI samples for a given percentage (for example 75%) of the signals increase by more than a threshold amount in a specified number of minutes, then it is assumed that the device has exited a building and a immediate position fix is taken.

7) The RSSI samples are averaged for each signal over a time interval and the cellular signal Doppler is measured for each signal. If the RSSI samples are changing rapidly and the Doppler is low, then the device is assumed to be carried by a pedestrian and the GPS duty cycle is set accordingly.

While various embodiments of the invention have been described, it will be apparent to those of ordinary skill in the art that many more embodiments and implementations are possible within the scope of this invention. Moreover, it will be understood that the foregoing description of numerous implementations has been presented for purposes of illustration and description. It is not exhaustive and does not limit the claimed inventions to the precise forms disclosed. Modifications and variations are possible in light of the above description or may be acquired from practicing the invention. The claims and their equivalents define the scope of the invention. Accordingly, the invention is not to be restricted except in light of the attached claims and their equivalents.

What is claimed is:

1. A wireless device including a transceiver that utilizes a power supply, the wireless device comprising:
a Global Positioning System (“GPS”) section having a plurality of GPS subsystems; and
a power controller in signal communication with the power supply and the GPS section, wherein the power controller is configured to selectively power each GPS subsystem from the plurality of GPS subsystems.

2. The wireless device of claim 1, wherein the power controller is further configured to receive an input power control signal.

3. The wireless device of claim 2, wherein the input power control signal is a measurement signal from the transceiver.

4. The wireless device of claim 3, wherein the measurement signal from the transceiver is an RSSI measurement signal.

5. The wireless device of claim 3, wherein the measurement signal from the transceiver is a Doppler measurement signal.

6. The wireless device of claim 2, wherein the input power control signal is produced by a motion sensor.

7. The wireless device of claim 2, wherein the input power control signal includes velocity measurements from the GPS section.

8. The wireless device of claim 1, wherein the plurality of GPS subsystems includes at least one radio frequency (“RF”) GPS subsystem, a baseband GPS subsystem, and a processor GPS subsystem.

9. The wireless device of claim 1, wherein the GPS section is capable of operating as a timing receiver in a weak signal environment.

10. The wireless device of claim 1, wherein the GPS section is capable of managing the need for bit synchronization, frame synchronization, or both.

11. The wireless device of claim 10, wherein the GPS section is capable of operating in a maintenance mode that maintains a time uncertainty for the GPS section to within ±¼ of a coarse/acquisition (“C/A”) code period.

12. The wireless device of claim 1, wherein the GPS section is capable of operating in a low-power mode that wakes up occasionally to capture a relatively short sequence of radio frequency (“RF”) sample data.

13. The wireless device of claim 12, further including a real-time clock (“RTC”).

14. The wireless device of claim 13, wherein the RTC is capable of running at 32,768 Hz.

15. The wireless device of claim 13, wherein the GPS section is capable of capturing data that is synchronized to predictable data segments.

16. The wireless device of claim 15, wherein the predictable data segments are telemetry data (“TLM”) or predictable hand-over-word (“HOW”) words of data.

17. The wireless device of claim 16, wherein GPS section is capable of utilizing longer coherent integration utilizing data stripping to enable measurements of data at lower signal levels.

18. The wireless device of claim 1, wherein the plurality of GPS subsystems includes:
at least one radio frequency (“RF”) GPS subsystem;
a baseband GPS subsystem; and
a processor GPS subsystem; and
wherein the power controller is capable of turning off the at least one RF GPS subsystem in response to the GPS section receiving GPS samples that are processed by the baseband GPS subsystem.

19. The wireless device of claim 1, further including a real-time clock (“RTC”) that has a frequency error as a function of temperature.

20. The wireless device of claim 1, further including a real-time clock (“RTC”) and wherein the GPS section is capable of receiving GPS samples that have a GPS sampling interval frequency that is adaptive.

21. The wireless device of claim 20, wherein the GPS sampling interval frequency is adaptive based on an observed clock frequency of the RTC.

22. The wireless device of claim 21, wherein the GPS sampling is capable of being adapted based on cellular RSSI measurements.

23. The wireless device of claim 22, wherein the GPS sampling has a duty cycle that is 1%.

24. The wireless device of claim 23, wherein the 1% duty cycle is aligned with a 30-bit GPS data word and the selected data words cycle through GPS ephemeris and clock data and the GPS section is capable of reducing the turn on time when current ephemeris and clock data have already been collected.

25. The wireless device of claim 23, wherein the GPS section is capable of reducing the duty cycle to 0.0125% when the RSSI measurements do not change significantly over the interval.

26. The wireless device of claim 25, wherein the GPS section is capable of resetting the duty cycle to 1% when the RSSI measurements changes significantly.

27. The wireless device of claim 20, wherein the power controller is further configured to receive an input power control signal, wherein the input power control signal is produced by a motion sensor, and wherein GPS sampling is capable of being varied depending on the input control signal.

28. The wireless device of claim 27, wherein the GPS sampling has a duty cycle that is reduced whenever the wireless device is stationary.

29. The wireless device of claim 28, wherein RSSI measurements are utilized to determine that the wireless device is stationary.

30. The wireless device of claim 28, wherein Doppler shift measurements are utilized to determine that the wireless device is stationary.

31. The wireless device of claim 28, wherein the duty cycle is reduced when the wireless device is moving faster than a predetermined threshold.

32. The wireless device of claim 31, wherein the predetermined threshold is 10 miles per hour.

33. The wireless device of claim 1, wherein the wireless device includes a transceiver type chosen from a group consisting of a cellular transceiver, a Wi-Fi transceiver, a Wi-Max transceiver, and a satellite transceiver.

34. The wireless device of claim 1, wherein the wireless device is a type of wireless device chosen from a group consisting of a notebook computer, a cordless telephone handset, a satellite telephone handset, a voice-over Internet protocol (“VoIP”) handset, and a cellular handset.

35. The wireless device of claim 1, further including a real-time clock (“RTC”) that has a time value and frequency value and wherein the time and frequency values are capable of being updated based on a signal from a Temperature Controlled Crystal Oscillator (“TCXO”) that has a TCXO frequency.

36. A power controller utilized in a wireless device having a Global Positioning System (“GPS”) section having a plurality of GPS subsystems, the power controller comprising:
a first input capable of receiving an input power signal from a power source within the wireless device;
an second input capable of receiving an input power control signal;
a plurality of outputs, wherein each output from the plurality of outputs is capable of being in signal communication with a corresponding GPS subsystem from the plurality of GPS subsystems; and
a controller capable of both selecting each output from the plurality of outputs and sending a power signal from the selected output to the corresponding GPS subsystem.

37. The power controller of 36, wherein the input power control signal is a measurement signal from a transceiver in the wireless device.

38. The wireless device of 37, wherein the measurement signal from the transceiver is an RSSI measurement signal.

39. The wireless device of 37, wherein the measurement signal from the transceiver is a Doppler measurement signal.

40. The wireless device of 36, wherein the input power control signal is produced by a motion sensor.

41. The wireless device of 36, wherein the input power control signal includes velocity measurements from the GPS section.

42. The wireless device of 36, wherein the plurality of GPS subsystems includes at least a radio frequency (“RF”) GPS subsystem, a baseband GPS subsystem, and a processor GPS subsystem.

43. A method for utilizing a power controller having a plurality of outputs within a wireless device that includes a Global Positioning System (“GPS”) section having a plurality of GPS subsystems, the method comprising:
receiving an input power signal from a power source within the wireless device at the power controller;
receiving an input power control signal at the power controller;
selecting an output from the plurality of outputs; and
sending an output power signal with the selected output from the power controller to a GPS subsystem from the plurality of GPS subsystems.

44. The method of 43, wherein receiving the input power control signal includes receiving a measurement signal from a transceiver in the wireless device.

45. The method of 44, wherein receiving the measurement signal from the transceiver includes receiving an RSSI measurement signal.

46. The method of 44, wherein receiving the measurement signal from the transceiver includes receiving a Doppler measurement signal.

47. The method of 43, wherein receiving the input power control signal includes receiving a motion sensor signal from a motion sensor in the wireless device.

48. The method of 43, wherein receiving the input power control signal includes receiving a velocity measurement signal from the GPS device.
